(19) United States
(12) Patent Application Publication
(10) Pub. No.: US 2011/0047316 A1
(43) Pub. Date: Feb. 24, 2011

(54) SOLID STATE MEMORY DEVICE POWER OPTIMIZATION

(75) Inventors: Munif M. Farhan, Round Rock, TX (US); Michael S. Banks, Round Rock, TX (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 12/543,911

(22) Filed: Aug. 19, 2009

(51) Int. Cl. G06F 12/00; G06F 12/02; G06F 1/32

(52) U.S. Cl. 711/103; 713/320; 711/E12.001; 711/E12.008

(57) ABSTRACT

Memory device power optimization includes operating a memory device, wherein the memory device includes a plurality of data channels and each of the plurality of data channels includes a plurality of data storage units. A controller receives a command to enable a power saving feature and determines a frequency of accessing of data stored in the data storage units, sorts the data into the data channels according to the frequency of the accessing of the data and powers down the data channels that are storing data with a frequency of accessing the data that is below a pre-determined threshold value.

### BACKGROUND

The present disclosure relates generally to information handling systems (IHSs), and more particularly to solid state memory device power optimization for an IHS.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Reduced power consumption is an IHS feature which is becoming more important, especially for portable IHSs. Data storage devices, such as hard disk drives (HDDs) and solid state drives (SSDs), generally have a power consumption of about 7% to 12% of the IHS's total notebook power budget. Generally, SSDs provide a power advantage over traditional HDDs, but as newer SSDs focus on higher performance, SSD power consumption for the SSDs is also increasing. For example, faster SSDs with more data channels and faster data rates increase the power consumption for the SSD 126 and in turn, the IHS 100. Improving power performance for such drives may increase overall system idle time, which may result in savings from other components of the system.

Accordingly, it would be desirable to provide improved memory device power optimization to reduce power consumption of an IHS.

### SUMMARY

According to an embodiment, memory device power optimization includes operating a memory device, wherein the memory device includes a plurality of data channels and each of the plurality of data channels includes a plurality of data storage units. A controller receives a command to enable a power saving feature and determines a frequency of accessing of data stored in the data storage units, sorts the data into the data channels according to the frequency of the accessing of the data and powers down the data channels that are storing data with a frequency of accessing the data that is below a pre-determined threshold value.

### BRIEF DESCRIPTION OF THE DRAWINGS

FIG. 1 illustrates an embodiment of an information handling system.

FIG. 2 illustrates a block diagram of an embodiment of a portion of the solid state drive of FIG. 1.

FIG. 3 illustrates a flow chart of an embodiment of a method for optimizing power performance for the solid state drive of FIG. 2.

FIG. 4 illustrates a block diagram of the solid state drive of FIG. 2, optimized for power performance using the method of FIG. 3.

### DETAILED DESCRIPTION

For purposes of this disclosure, an information handling system (IHS) includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, read only memory (ROM), and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit communications between the various hardware components.

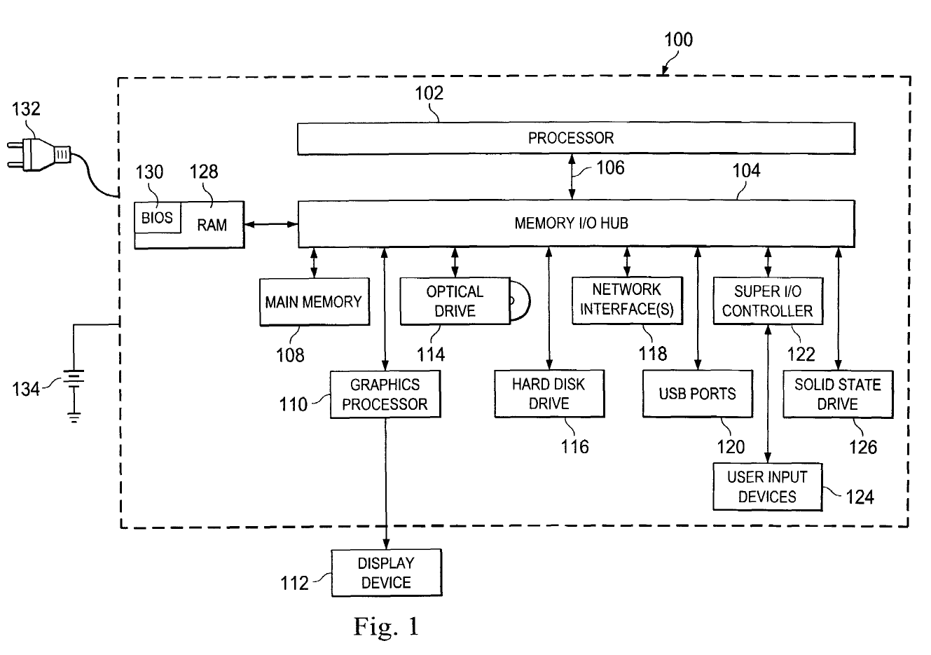

FIG. 1 is a block diagram of one IHS 100. The IHS 100 includes a processor 102 such as an Intel Pentium™ series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112.

Other resources can also be coupled to the system through the memory I/O hub 104 using a data bus, including an optical drive 114 or other removable-media drive, one or more hard disk drives (HDD) 116, one or more network interfaces 118, one or more Universal Serial Bus (USB) ports 120, and a super I/O controller 122 to provide access to user input devices 124, etc. The IHS 100 may also include a solid-state drive (SSDs) 126 in place of, or in addition to main memory 108, the optical drive 114, and/or a hard disk drive 116. It is understood that any or all of the drive devices 114, 116, and 126 may be located locally with the IHS 100, located remotely from the IHS 100, and/or they may be virtual with respect to the IHS 100.

The IHS 100 of FIG. 1 also includes a random access memory (RAM) 128 coupled to the memory I/O hub 104 for storing data usable by the processor 102. The RAM 128 includes a basic input/output system (BIOS) 130 that generally controls operations of the IHS 100 upon start-up and until an operating system takes over control of operations for the IHS 100.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources. The IHS 100 operates using line voltage power 132, such as 120 vac, and/or battery power from a battery 134.

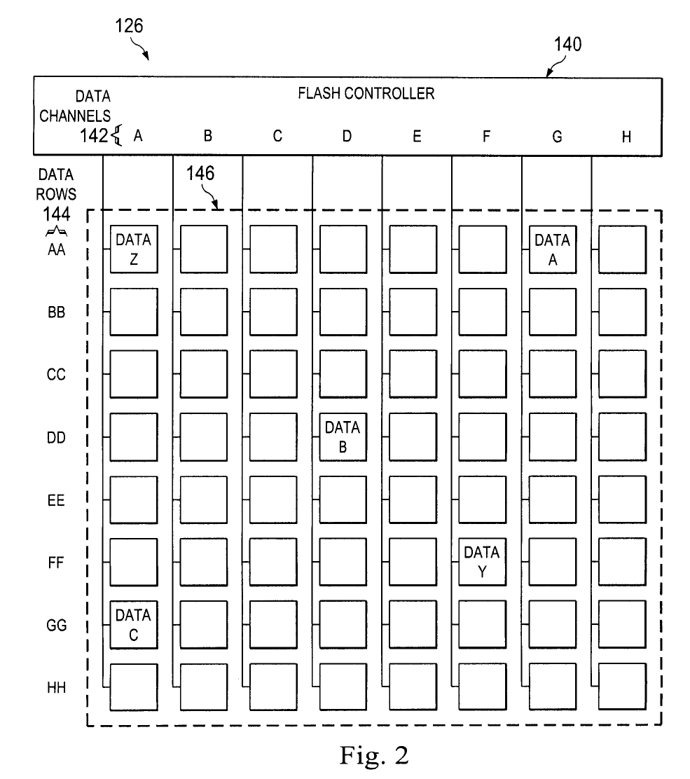

FIG. 2 illustrates a block diagram of an embodiment of a portion of the solid-state drive (SSD) 126. The SSD 126 is a data storage device that uses non-volatile solid-state memory for storing data. The SSD 126 includes a controller 140 to control writing and reading of data for the SSD 126. The controller 140 communicates with the memory I/O hub 104. Accordingly, the BIOS 130 can provide instructions to the SSD 126. The SSD 126 organizes the storage of data in a plurality of data channels 142 (A-H), and a plurality of data rows 144 (AA-HH). At the intersection of each data channel 142 and each data row 144 is a data storage unit 146. Each data storage unit 146 is a non-volatile memory storage device, such as a flash memory device, that receives data that is written to it under instruction from the controller 140. Each data storage unit 146 stores the data written to it and provides the data when instructed to do so by the controller 140.

For example, Data A has been written to and stored in a data storage unit at the intersection of data channel G and data row AA. Similarly, Data B is stored at the intersection of D and DD; Data C is stored at the intersection of A and GG; Data Y is stored at the intersection of F and FF; and Data Z is stored at the intersection of A and M. In the alternative, the data stored in the memory units 146 may be stored in other locations (e.g., other intersections of data channels 142 and data rows 144). Data can be distributed across multiple channels and the controller 140 will migrate the data to active channels.

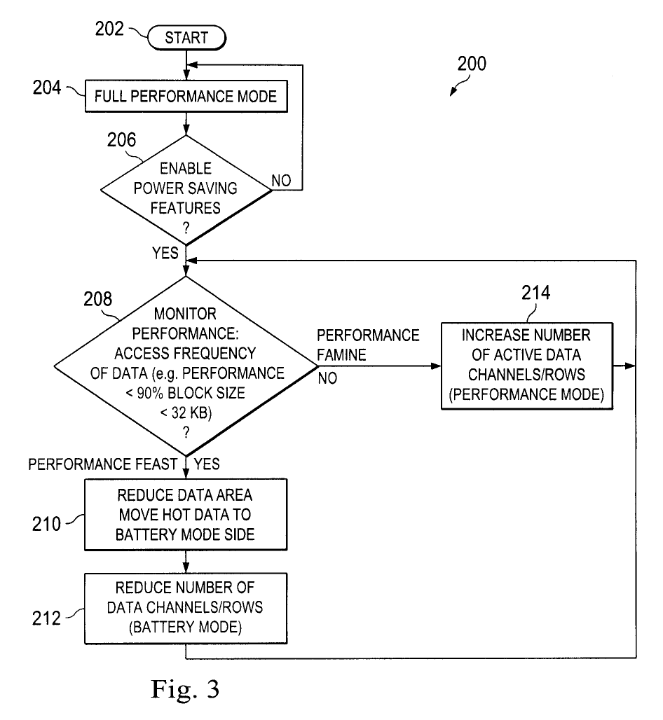

FIG. 3 illustrates a flow chart of an embodiment of a method 200 for optimizing power performance for the SSD 126. The method 200 begins at block 202 where the IHS 100 is powered on for operation. The method 200 proceeds to block 204 where the BIOS 130 instructs the controller 140 to operate the SSD 126 in a full performance mode where all of the data storage units 146 continually receive electrical power and are ready for writing or reading data. The method 200 then proceeds to decision block 206 where the method determines whether the IHS 100 has been instructed to enable a power saving feature and enter a power saving mode, with respect to the SSD 126. If no, the method 200 has not been instructed to enable the power saving feature, the method 200 returns to block 204 and operates the SSD 126 at standard power, leaving all data storage units 146 powered. On the other hand, if yes, the method 200 has been instructed to enable the power saving feature, the method 200 proceeds to decision block 208. At decision block 208, the method 200 monitors a frequency of accessing the data stored in data storage units 146 of the SSD 126.

For example, the method 200 determines a number of times that Data A, Data B, etc. is written and read. The method 200 then determines whether the frequency of accessing a given data is greater than a pre-determined level, such as the data is accessed more than 2 times per day. In addition, the method 200 may determine that the SSD 129 is operating in a high performance range and has an adequate available storage space block size available for holding data. In one embodiment, the method 200 determines if the usage of the SSD 126 is near a saturation point. The method 200 also determines if the SSD 126 is relatively idle. If yes, the method 200 determines access of data in SSD 126 is low in comparison to an access capacity of the SSD 126, the method 200 proceeds to block 210. At block 210, the method 200 moves data that is used the most or is otherwise above the pre-determined frequency level closer together, such as in the same or a near data channel 144.

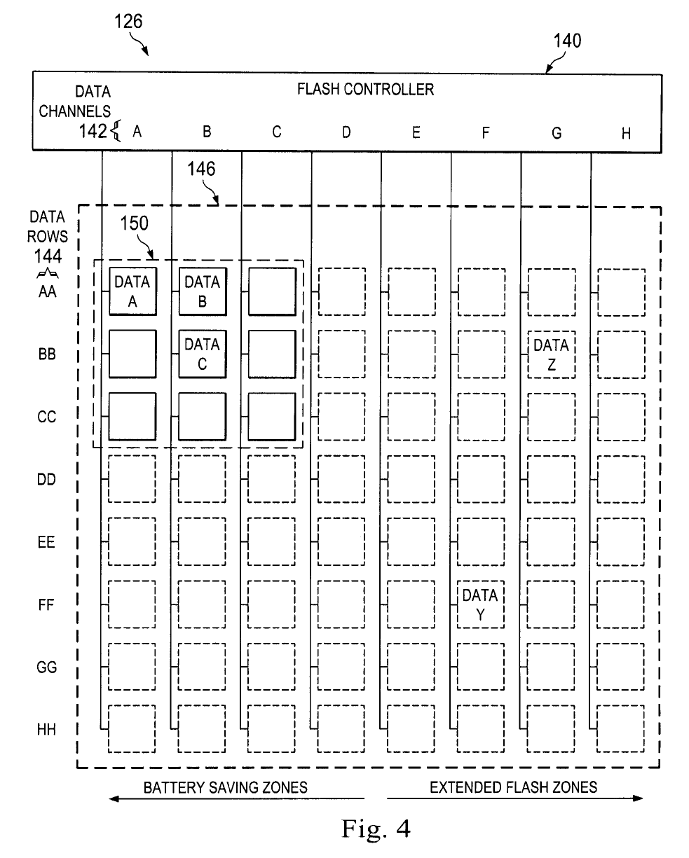

FIG. 4 illustrates a block diagram of the solid state drive 126, shown in FIG. 2, where the data storage has been optimized for power performance using the method 200. Specifically, for this example, the method 200 has determined that accessing of Data A, Data B and Data C are above the pre-determined threshold and accessing of Data Y and Data Z are below the pre-determined threshold. Therefore, Data Y is left at data storage unit F FF. Data Z is moved from data storage unit A AA to data storage unit G BB. Additionally, the more used data, Data A, Data B and Data C are moved to data storage units A AA, B AA and B BB, respectively. In this way, the more used data is stored in close proximity to one another. Other combinations of moving data to other data storage units are contemplated.

The method 200 continues from block 210 to block 212 where the method 200 reduces the number of available data channels 142 by powering down data channels with rarely used data. In the example provided above, the method 200 electrically powers down data channels D, E, F, G and H. Similarly, in an alternative embodiment, the method 200 may power down data rows, such as DD, EE, FF, GG and HH, to further save electrical power. As shown in FIG. 4, remaining powered data storage units 150 retain electrical power while the other data storage units are powered down. After the method 200 reduces the number of available data channels 142, and possibly data rows 144, the method 200 returns to decision block 208 to continue monitoring data access frequency and SSD 126 performance.

Referring now back to block 208, if no, the method 200 does not determine that the access of data in the SSD 126 is low in comparison to an access capacity of the SSD 126 or the IHS 100 has a need for more available data channels 142 and/or data rows 144 in the SSD 126, the method 200 proceeds to block 210 where the method 200 increases the number of available data channels 142 and/or available data rows 144 by powering up one or more of the powered data channels 142 and/or data rows 144. The method 200 then returns to decision block 208 to continue monitoring data access frequency and SSD 126 performance. The method 200 is terminated when the IHS 100 is powered down. In the alternative, the method 200 may be terminated by an automatic or manual termination routine, such as in the BIOS 130.

The present disclosure provides a system having a reduced power/battery saving mode SSD (e.g., SSD 126) by localizing frequently used data into a smaller flash zone (e.g., 150) which requires less electrical power consumption, and then powering down less frequently used data zones. The less frequently used data will be stored in extended flash zones that can be turned off during operation to save electrical power. While the IHS 100 is in a battery mode, it may also utilize traditional power saving features, such as aggressive SATA power modes, low sleep timers, etc.

The battery saving mode disclosed herein is activated as dynamic by the IHS 100 where the controller 140 monitors the usage and data request and enters a battery saving mode as needed, such as where there are continuous small block data requests, and/or at high idle times. In the alternative, the battery saving mode may be activated as fixed by the BIOS 130 where a traditional BIOS HDD acoustics or quiet mode is utilized to optimize the SSD 126.

Accordingly, the present disclosure provides for optimizing the SSD 126 performance while in the battery mode using the power saving feature and data access activity monitoring. The controller 140 monitors SSD 126 data request patterns/idle timers and determines the amount of device utilization. A feature of this disclosure is the use of dynamically enabled low power operational features, which allow the SSD 126 to operate at a lower power mode while minimally impacting performance. While in a low power/battery mode, if the controller 140 detects that the SSD 126 is close to usage saturation, the controller 140 may increasingly disable power saving features to minimize the performance degradation associated with the power saving features and power up previously powered down data channels 142 and/or data rows 144. If usage continues to be high, more power saving features can be adjusted down and/or disabled completely.

The present disclosure may dynamically adjust settings for a Device Initiated Power Management (DIPM) system and slumber/inactivity timers, depending on the frequency and duration of idle SSD 126 periods. The SSD 126 may also dynamically optimize its own sleep timers rather than depending on the user to guess and set the system (e.g., Host Initiated Power Management (HIPM)) timeouts before a device goes to sleep. If longer and less frequent idle times are detected, the sleep timers can be adjusted to go into a deeper sleep (slumber) mode more quickly. Conversely, if idle times are extremely frequent and short, the sleep timers can be adjusted so the device is not put into sleep during these short periods. SSDs 126 have no spin-up time (as opposed to HDDs 116), so the power savings achieved by manipulating the HIPM/DIPM timers is minimal. The SSD HIPM/DIPM power management can be improved by making the system BIOS 130 aware that the SSD 126 can behave like a HDD. For example, the SSD 126 could go into deep sleep (slumber) in its own within milliseconds of receiving and responding to a command. The system BIOS 130 however, may tell the SDD 126 to go into a lighter (partial) sleep as if it was an HDD 116 to avoid the spin down/up power, which is non existent in an SSD. The system will then send the SSD 126 a slumber command again causing it to wake up to execute the request before finally going back to sleep (slumber).

The SSD 126 may operate under the SATA standard. SATA SSD devices support a 3 G b/s data rate and will support faster data rates, such as 6 G b/s, in the future. According, the faster data transfer speeds require increasingly higher power. With the present disclosure it is contemplated that during periods of light usage and higher distribution of small block transfers, the data transfers over a SATA bus can be slowed down to save power without impacting performance.

In summary, SSDs 126 provide multiple data channels of speed data transfer and allow simultaneous background housekeeping activities. Higher performance SSDs have more data channels. In an embodiment of the present disclosure, a power savings can be accomplished by dynamically reducing the number of active data channels 142 that are enabled. SSDs 126 include multiple banks of flash memory in the data rows 144. Traditionally, SSDs enable and power all flash chips in the data rows 144 and the data channels 142. However, to save power several rows of flash memory 144 can be temporarily powered off. More frequently accessed data can be moved to the powered banks while little used or empty data blocks can be moved to the banks which are powered off. Wear leveling can be accomplished both by varying which banks are temporarily powered off and by delayed more advanced wear leveling to idle periods when the device is in full power mode.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A method comprising:
operating a memory device, wherein the memory device includes a plurality of data channels and each of the plurality of data channels includes a plurality of data storage units;
receiving a command to enable a power saving feature;
determining a frequency of accessing of data stored in the data storage units;
sorting the data into the data channels according to the frequency of the accessing of the data; and
powering down the data channels that are storing data with a frequency of accessing the data that is below a pre-determined threshold value.

2. The method of claim 1, including powering down the data channels in response to operating in a battery powered mode.

3. The method of claim 2, including powering up the data channels in response to operating in a line powered mode.

4. The method of claim 1, including sorting the data into the data storage units according to the frequency of accessing the data.

5. The method of claim 4, including powering down the data storage units that are storing data with a frequency of accessing the data that is below a pre-determined threshold value.

6. The method of claim 1, including wear leveling the data storage units by powering up a data channel and moving the data into the powered up data channel.

7. The method of claim 1, including initiating in a basic input/output system (BIOS) a set of instructions to control the power saving feature, in response the receiving the command to enable the power saving feature.

8. An information handling system (IHS) comprising:
a processor;
a memory device coupled to the processor;
a sold state memory device (SSD) coupled to the processor, wherein the SSD includes a plurality of data channels and each of the plurality of data channels includes a plurality of data storage units; and
a controller that, in response to receiving a command to enable a power saving feature;
determines a frequency of accessing of data stored in the data storage units;
sorts the data into the data channels according to the frequency of the accessing of the data; and
powers down the data channels that are storing data with a frequency of accessing the data that is below a pre-determined threshold value.

9. The IHS of claim 8, wherein the controller powers down the data channels in response to operating in a battery powered mode.

10. The IHS of claim 9, wherein the controller powers up the data channels in response to operating in a line powered mode.

11. The IHS of claim 8, wherein the controller sorts the data into the data storage units according to the frequency of accessing the data.

12. The IHS of claim 11, wherein the controller powers down the data storage units that are storing data with a frequency of accessing the data that is below a pre-determined threshold value.

13. The IHS of claim 8, wherein the controller wear levels the data storage units by powering up a data channel and moving the data into the powered up data channel.

14. The IHS of claim 8, including a basic input/output system (BIOS) that initiates the power saving feature, in response the receiving the command to enable the power saving feature.

15. A device comprising:
a plurality of solid state data channels, each of the plurality of data channels including a plurality of data storage units; and
a controller that, in response to receiving a command to enable a power saving feature;
determines a frequency of accessing of data stored in the data storage units;
sorts the data into the data channels according to the frequency of the accessing of the data; and
powers down the data channels that are storing data with a frequency of accessing the data that is below a pre-determined threshold value.

16. The device of claim 15, wherein the controller powers down the data channels in response to operating in a battery powered mode.

17. The device of claim 16, wherein the controller powers up the data channels in response to operating in a line powered mode.

18. The device of claim 15, wherein the controller sorts the data into the data storage units according to the frequency of accessing the data.

19. The device of claim 18, wherein the controller powers down the data storage units that are storing data with a frequency of accessing the data that is below a pre-determined threshold value.

20. The device of claim 15, wherein the controller wear levels the data storage units by powering up a data channel and moving the data into the powered up data channel.
